(19) United States
(12) Patent Application Publication
(10) Pub. No.: US 2011/0311686 A1
(43) Pub. Date: Dec. 22, 2011

(54) Encrusted Cheese Dip and Method

(76) Inventors: Guy Beardsmore, Plymouth, WI (US); Ken Lightfield, Sherwood, WI (US); Bridget Bartel, Chilton, WI (US)

(21) Appl. No.: 12/818,884

(22) Filed: Jun. 18, 2010

(51) Int. Cl. A23C 19/00

(52) U.S. Cl. 426/92; 426/94; 426/296; 426/291

(57) ABSTRACT

A food product and method including a portion of cheese configured in a single serving size. The portion of cheese is configured to melt at a temperature of less than about 110° F. A batter and bread coating encases the portion of cheese and the coating further includes a wheat flour which has been heat treated. The coating comprises less than 25%, by weight, of the food product. In one embodiment, the coating further comprises a plurality of ingredients suitable for heating longer than five minutes without a cheese blowout.

### BACKGROUND OF THE INVENTION

The present invention relates to food products and more particularly to a bread and batter encrusted portion of food, for example cheese, that is heated prior to serving.

It is known in the art to provide filled cheese products and that the filled cheese products can be fried either in a pan fried method or in a deep fried method. It is also known to bread food products, such as cheese, with a batter coating and then par fry and/or freeze the food product.

It is also known that heating, for example, by deep frying, can cause a cheese filling to “blow out” from the batter coating if the food product is fried for longer than three minutes. It is also known that the batter coating typically amounts to 30% or more of the final food product weight in order to prevent a cheese blow out. A cheese blow out, as known in the art, of the cheese melting within the encrusted batter during the frying process with the cheese flowing out of the encrusted batter into the cooking oil. Such action not only results in an unusable food product but also contaminates the cooking oil.

In order to enhance the market appeal of the food product of the present disclosure, it should also be inexpensive to prepare to thereby afford it the broadest possible market. Finally, it is also an objective that all of the aforesaid advantages and objectives be achieved without incurring any substantial relative disadvantage.

### SUMMARY OF THE INVENTION

The disadvantages and limitations of the background art discussed above are overcome by the present disclosure.

There is provided a food product including a portion of cheese configured in a single serving size. The portion of cheese is configured to melt at a temperature of less than about 110° F. A batter and bread coating uniformly encases the portion of cheese. The coating comprises less than 25%, by weight, of the food product and is composed of a coating of a plurality of ingredients suitable for heating without a cheese blow out. In another embodiment, the coating further includes a wheat flour which has been heat treated. In another embodiment the coating includes a plurality of ingredients suitable for heating longer than 5 minutes.

There is additionally provided a food product including a portion of cheese configured in a single serving size. The batter and bread coating uniformly encases the portion of cheese, with the coating composed of a plurality of ingredients suitable for heating for longer than five minutes without a cheese blow out. In one embodiment the portion of cheese melts at a temperature of less than about 110° F. In another embodiment, the coating comprises less than 25%, by weight, of the food product.

There is also provided a method of making a food product. The method includes providing a quantity of cheese and grinding the cheese. The ground cheese is blended with selected ingredients to create a cheese matrix. The cheese matrix is formed into an individual serving size puck. A coating is applied to the puck and the coated puck is par fried. The par fried coated puck is frozen with a quick freeze process and the individual quick frozen par fried coated puck product is packaged for shipment. In another embodiment, the step of applying the coating further includes applying a first batter to the puck, with the first batter including a natural, heat treated wheat flour, then applying a breading mix to the batter coated puck and applying a second batter to the breaded puck. The second batter includes the natural, heat treated wheat flour. In another embodiment, the breading includes a natural heat treated wheat flour. In another embodiment a method further provides that the coating comprises less than 25%, by weight, of the food product and the portion of cheese melts at a temperature less than about 110° F.

The food product of the present disclosure is also of inexpensive to enhance its market appeal and to thereby afford it the broadest possible market. Finally, all of the aforesaid advantages and objectives are achieved without incurring any substantial relative disadvantage.

### DESCRIPTION OF THE DRAWINGS

These and other advantages of the present disclosure are best understood with reference to the drawings, in which:

FIG. 1 is a perspective illustration of a batter and bread encrusted par fried food product.

FIG. 2 is a perspective illustration of the food product illustrated in FIG. 1 with a portion of the encrusted coating removed and an interior melted cheese matrix exposed.

FIG. 3 is a top plan view of exemplary embodiments of two batter and bread encrusted par fried food products, with each being a single serving.

FIG. 4 is a cross-sectional view of the two batter and bread encrusted par fried food products illustrated in FIG. 3.

FIG. 5 is a schematic block diagram of an exemplary embodiment of steps to manufacture a batter and bread encrusted portion of cheese food product.

FIG. 6 is a schematic illustration of an exemplary embodiment of a system for making a batter and bread encrusted cheese dip food product.

### DETAILED DESCRIPTION OF THE EXEMPLARY EMBODIMENTS

Before describing exemplary embodiments of an encrusted cheese dip food product several comments are in order. The food service industry typically looks for new, unique cheese appetizers to add to their menu. There are hot dips that are served in a bowl that chips or bread are dipped into and consumed as appetizers, prior to a meal. Such hot dip appetizer menus typically are provided for a plurality of individuals and not in single size servings. It is also known in the industry that bite-size cheese encrusted food products are provided however the preparation is different as will be described below.

Some existing cheese appetizers include a breading which constitutes a coating for the cheese product that exceeds 30% by weight of the final food product. Typically the coating on the cheese appetizer is in the range of 50-60% by weight. The problem with such heavy coating is that during the deep frying process typically the frying exceeds three minutes in order to completely cook the coating. As a result of such long cooking time the cheese encrusted in the coating becomes so hot that it blows out of the coating. Such cheese blowout results in contaminated cooking oil and also results in an appetizer that is unsuitable for serving to end users. Reducing the cooking time to avoid a cheese blowout results in a portion of the coating not being cooked and creating a doughy interface between the coating and the interior cheese which also results in an unsuitable food serving for an end user.

The encrusted cheese dip food product 10 disclosed herein provides a unique combination of cheese and other ingredients that is a hot dip with a battered and breaded coating that serves as the carbohydrate carrier and is the edible dipping device to dip into the hot dip cheese matrix 38. The food product 10 is configured for deep frying for longer than five minutes at 350° F. in deep fry oil without a cheese blowout and resulting in a very crunchy, sturdy food product 10.

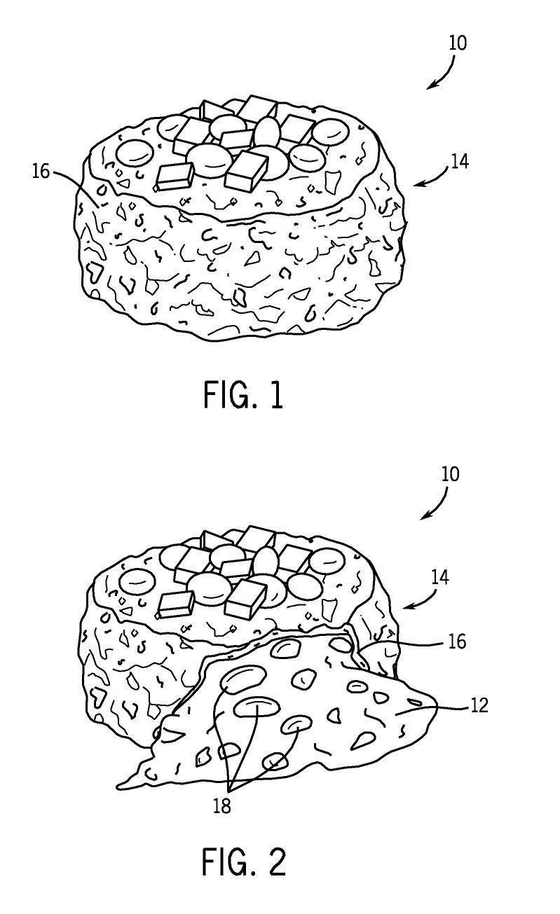

Referring now to the FIGS. 1-6, FIG. 1 illustrates a food product 10 in a single serving size 14 and includes a coating 16 encasing a cheese matrix (not visible). Such serving size 14, typically in the industry, is referred to as a “puck”. The puck can be of any suitable shape such as a spherical dome shape, a ball, or flattened cylinder. The puck shape is determined by the manufacturer based on the type of cheese matrix, end use, and customer request, etc.

FIG. 2 illustrates the food product 10 illustrated in FIG. 1 with a portion of the coating 16 removed, exposing the cheese matrix 38 contained in the interior of the single serving size 14 food product 10. The portion of cheese 12 is configured in a single serving size 14 wherein the portion of cheese melts at a temperature less than 110° F. The portion of cheese 12 may include food ingredients 18 as determined by the manufacturer. The cheese matrix 38 is encased in a batter and bread coating 16 with the coating 16 comprising less than 25%, by weight, of the final food product 10.

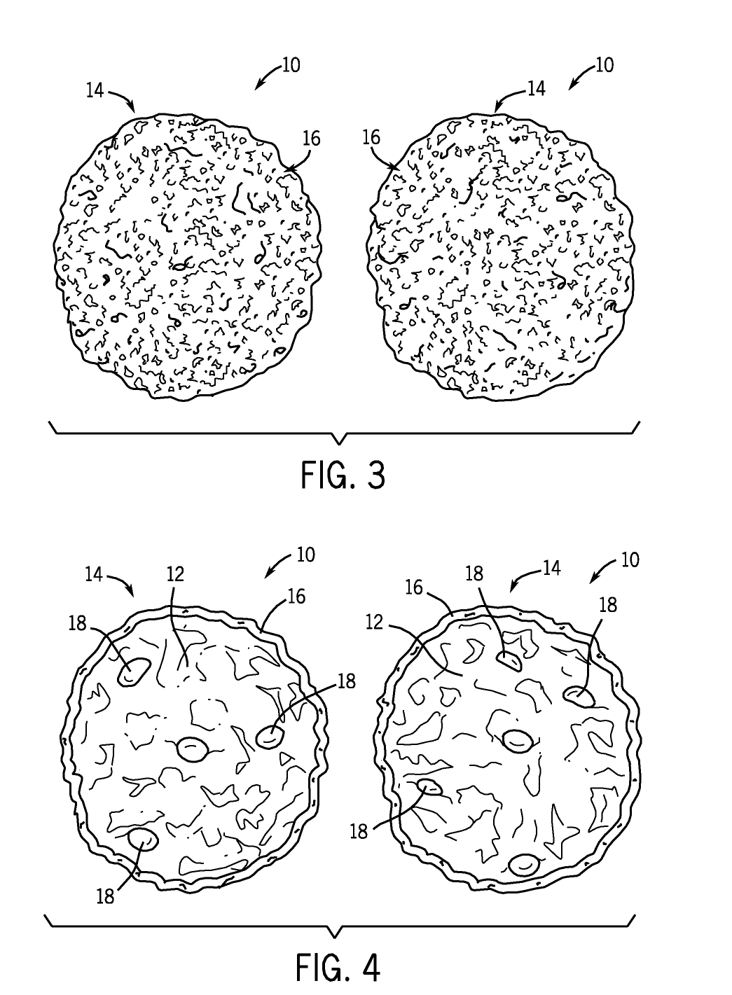

FIGS. 3 and 4 illustrate two par fried individual serving size pucks. FIG. 3 illustrates the food product 10 encrusted with a coating 10. The food product 10 has been par fried (explained below). The food product 10 will be served to an end user after deep frying to melt the cheese portion 12, in the cheese matrix 38. FIG. 4 illustrated cross-sectional views of the food products in FIG. 3. The cheese matrix 38 includes the cheese portion 12 and various food ingredients 18 as described below. The par frying, prior to quick freezing the pucks, helps to maintain the shape and structural stability of the food product 10 during packaging and shipment to an end user. The par frying step is a part of the process of manufacturing. The final heating occurs with the end user.

The batter and bread coating 16 includes a plurality of ingredients suitable for heating longer than five minutes without a cheese blowout. One ingredient is a heat treated natural wheat flour, for example as provided by Siemer Specialty Ingredients. The heat treated wheat flour provides texture and extended frying stability for the food product 10 and accounts for the less 25% by weight capability.

The amount of heat treated natural wheat flour used in the breading will vary based on the specific food product 10 being made. For example, in a spinach-artichoke puck the heat treated flour constitutes 40% of the breading mixture, with the breading mixture itself being less than 25%, by weight, of the final food product 10. In another example, the food product 10 is a queso cheese and the heat treated flour constitutes 20% of the breading mixture, with the breading mixture itself being less than 25%, by weight, of the final food product 10. It should be understood that the amount of heat treated natural wheat flour may be in the range of 15% to 50% of the final breading mixture based on the food product recipe being made.

The portion of cheese 12 can include a variety of food ingredients 18 which are dispersed in the portion of cheese 12. (See FIG. 2) The food ingredient 18 can be selected from a group consisting of pork, beef, turkey, chicken, fish, vegetable, legume, flavors, seasoning, condiments, stabilizers, and a combination of any two such food ingredients as determined by the manufacturer.

The food product 10 is configured to be heated to cook the coating 16 and melt the cheese matrix 38 encrusted by the coating 16. The preferred method of heating the food product 10 is by deep frying for greater than five minutes at 350° F. in frying oil. However it should be understood that the final preparation of the food product 10 can also be accomplished in a conventional, convection, impingement, and speed ovens as determined by the end user. It should be understood that during the manufacture of the food product 10 the coated puck is par fried at 400° F. for approximately thirty seconds. The par frying, depending on the cheese matrix, may be within the range of 20-45 seconds prior to the freezing step as will be described below.

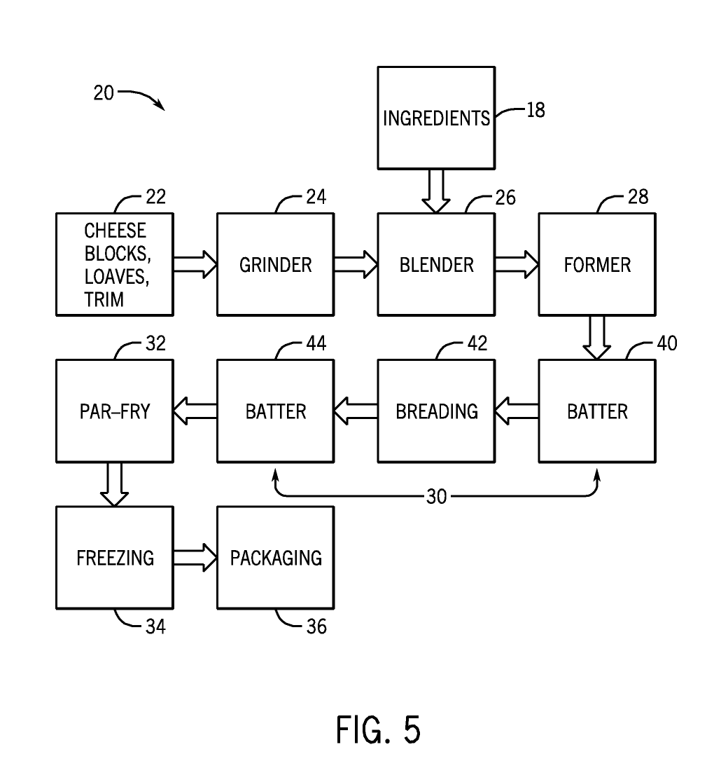

Referring now to FIG. 5, there is illustrated a block diagram of a method of making a food product 10. A quantity of cheese 22 that can be in the form of blocks, loaves or trim material from other processes is placed in a grinder apparatus 24. The grinder apparatus 24 breaks up the cheese pieces into a suitable size, for example, half inch, for blending.

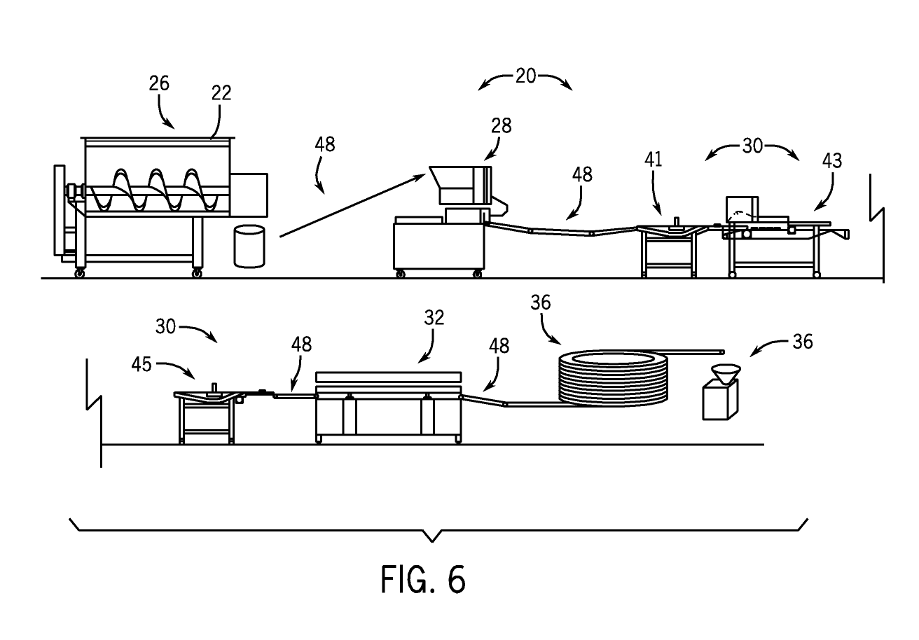

In one embodiment of the process for manufacturing 20 the food product 10 includes a separate grinder apparatus 24 or a shredder apparatus to reduce the size of the cheese, the ground cheese is moved to a separate blender apparatus 26 which blends food ingredients 18 as determined by the manufacturer. The system illustrated in FIG. 6 is an exemplary embodiment of the process for manufacturing 20 the food product 10 with the grinder 24 and blender 26 combined in a single apparatus. It should be understood that a shredder and blender may be combined in a single apparatus to prepare the quantity of cheese 22 for the forming apparatus. The recipe for blending the cheese with the food ingredients vary and may include several different types of food ingredients 18 as described above. Blending of a quantity of cheese in a food ingredients 18 creates a cheese matrix 38.

The forming apparatus 28 forms the cheese matrix 38 into a selected shape such as, for example, a spherical dome or a flattened cylinder. The shaped cheese matrix 38 now is in a form of a puck sized as the single serving greater than five ounces and approximately 3-5 inches in diameter. The forming apparatus can be, for example a machine supplied by Formax, Koppens, or other suitable food forming machines. It should be understood that a plurality of cheese matrix pucks can be formed with an appropriate amount of the cheese matrix provided to the former apparatus 28.

The cheese matrix pucks 38 are moved to a coating station 30 where a first batter 40 is applied to the puck by a first batter machine 41. The first batter 40 includes a natural, heat treated wheat flour such as supplied by Siemer Specialty Ingredients. After the first batter 40 is applied to the puck, a breading mix 42 is applied to the batter coated puck by a breading machine 43. A second batter 44 is applied to the breaded puck by a second batter machine 45 with the second batter 44 including the natural, heat treated wheat flour. It should be understood that the first batter 40 and the second batter 44 are composed of the same recipe even though they are applied at different times at the coating station 30. The batters 40 and 44 are composed of milk, milk products, wheat (including the heat treated natural wheat flour) and related grain, egg and egg products, salt, seasoning and colorings. The breading 42 typically is a bread crumb mixture composed of bleached wheat flour, yeast, sugar and salt and may include seasonings as determined by the manufacturer. The breading 42 may also include the natural heat treated wheat flour. The amount of treated wheat flour that is in the batter can vary between 0.5 to 10% (by weight of the final food product 10) but more usually between the range of 1 and 5% by weight of the final food product, but preferably the batter contains 1.8%, by weight of the final food product, of the heat treated wheat flour.

As illustrated in FIG. 6, the two batter machines 41 and 45 include a conveyor well that allows the food products 10 which are positioned on the transport conveyor 48 to be dipped in the respective batter machine for coating the cheese matrix 38 with the respective batter. The breading machine 43 applies the breading by moving the cheese matrix 38 through a curtain of the breading coating. An air knife apparatus may also be positioned after the breading machine to blow off excess breading as necessary.

After the cheese matrix puck 38 is coated at the coating station 30 each of the pucks are par fried at a par frying station 32. In the par frying station 32 the coated puck is immersed in a 400° F. fry oil for approximately 30 seconds. However it should be understood that depending on the composition of the cheese matrix 38 the par frying time may vary between 20 and 45 seconds as determined by the manufacturer. The par fried coated puck is then frozen in a quick freeze process producing an individual quick frozen (IQF) food product 10. The individual IQF par fried coated puck food product 10 is then packaged at a packing station 36 and maintained in the frozen state until appropriate heating by an end user.

It should be understood that several transport conveyors 48 are used to convey the pucks and food products 10 between the various processing stations and machines. The transport conveyor can be by a metal, plastic or other suitable food compatible material belt conveyor and can be a manual transfer. It is also contemplated that the entire manufacturing process 20 may be configured in a single continuous structural matrix.

As discussed above, at the coating station 30 the cheese matrix 38 is coated in the batter, breading, batter process with the total coating 16 being less than 25% by weight of the final food product 10. Also, the portion of cheese 12 that is used in the cheese matrix 38 melts at a temperature less than 110° F.

Although the foregoing description of the present disclosure has been shown and described with reference to particular embodiments and applications thereof, it has been presented for purposes of illustration and description and is not intended to be exhaustive or to limit the food product and method to the particular embodiments and applications disclosed. It will be apparent to those having ordinary skill in the art that a number of changes, modifications, variations, or alterations to the disclosure as described herein may be made, none of which depart from the spirit or scope of the present disclosure. The particular embodiments and applications were chosen and described to provide the best illustration of the principles of the method and food product and its practical application to thereby enable one of ordinary skill in the art to utilize the disclosure in various embodiments and with various modifications as are suited to the particular use contemplated. All such changes, modifications, variations, and alterations should therefore be seen as being within the scope of the present disclosure as determined by the appended claims when interpreted in accordance with the breadth to which they are fairly, legally, and equitably entitled.

What is claimed is:

1. A food product comprising:
a portion of cheese configured in a single serving size, wherein the portion of cheese melts at a temperature less than about 110° F.; and
a batter and bread coating uniformly encasing the portion of cheese, wherein the coating comprises less than about 25%, by weight, of the food product and is composed of a plurality of ingredients suitable for heating without a cheese blowout.

2. The food product of claim 1, wherein the coating further comprises a plurality of ingredients suitable for heating longer that 5 minutes.

3. The food product of claim 1, wherein the coating further includes a natural wheat flour which has been heat treated.

4. The food product of claim 1, further comprising a food ingredient dispersed in the portion of cheese.

5. The food product of claim 4, wherein the food ingredient is from a group consisting of beef, pork, chicken, turkey, vegetable, legume, flavors, seasoning, condiments, stabilizers, and a combination of any two such food ingredients.

6. The food product of claim 1, wherein heating includes one of par frying and deep frying.

7. A food product comprising:
a portion of cheese configured in a single serving size; and
a batter and bread uniformly coating encasing the portion of cheese, with the coating composed of a plurality of ingredients suitable for heating longer that 5 minutes without a cheese blowout.

8. The food product of claim 7, wherein the portion of cheese melts at a temperature less than about 110° F.

9. The food product of claim 7, wherein heating includes one of par frying and deep frying.

10. The food product of claim 7, wherein the coating comprises less than 25%, by weight, of the food product.

11. The food product of claim 7, wherein the coating further includes a natural wheat flour which has been heat treated.

12. The food product of claim 7, further comprising a food ingredient dispersed in the portion of cheese.

13. The food product of claim 12, wherein the food ingredient is from a group consisting of beef, pork, chicken, turkey, vegetable, legume, flavors, seasoning, condiments, stabilizers, and a combination of any two such food ingredients.

14. A method of making a food product comprising:
providing a quantity of cheese;
grinding the cheese;
blending the ground cheese with selected ingredients to create a cheese matrix;
forming the cheese matrix into an individual serving size puck;
applying a coating to the puck;
par-frying the coated puck;
freezing the par-fried coated puck with a quick freeze process; and
packaging the individual quick frozen par-fried coated puck food product.

15. The method of making a food product of claim 14, the step of applying the coating further comprising:
applying a first batter to the puck, the first batter including a natural, heat treated wheat flour;
applying a breading mix to the batter coated puck; and
applying a second batter to the breaded puck, the second batter including the natural, heat treated wheat flour.

16. The method of making a food product of claim 15, further comprising the step of applying a breading mix includes a natural, heat treated wheat flour.

17. The method of making a food product of claim 14, wherein the ingredients are selected from a group consisting of processed cheese, meat, fish, vegetables, legume, flavors, seasoning, condiments, stabilizers, and a combination of any two such ingredients.

18. The method of making a food product of claim 14, wherein the coating comprises less than 25%, by weight, of the food product and the portion of cheese melts at a temperature less than 110° F.
